(19) United States
(12) Patent Application Publication
(10) Pub. No.: US 2024/0186699 A1
(43) Pub. Date: Jun. 6, 2024

(54) SWITCHABLE PANEL ANTENNAS WITH PHASE SHIFTERS

(71) Applicant: ARRIS Enterprises LLC, Suwanee, GA (US)

(72) Inventor: Sima Noghanian, San Jose, CA (US)

(21) Appl. No.: 18/512,985

(22) Filed: Nov. 17, 2023

Related U.S. Application Data
(60) Provisional application No. 63/385,688, filed on Dec. 1, 2022.

(51) Int. Cl. H01Q 3/36; H01Q 3/24; H01Q 3/26; H01Q 21/06

(52) U.S. Cl. CPC H01Q 3/36; H01Q 3/24; H01Q 3/2658; H01Q 21/061

(57) ABSTRACT

Switchable antennas are provided that include an RF port, an antenna array that includes at least a first column of radiating elements, a second column of radiating elements and a third column of radiating elements, and a feed network coupled between the RF port and the antenna array. The feed network includes a power divider whose input is coupled to the RF port and whose output is coupled to a phase shifter.

### BACKGROUND

The present invention generally relates to radio communications and, more particularly, to antennas that have adjustable radiation patterns.

Wireless communications systems such as, for example, cellular communications systems and wireless local area networks (“WLANs”), are well known in the art. In a cellular communications system, a geographic area is divided into a series of regions that are referred to as “cells” that are served by respective base stations. Each base station may include baseband equipment, radios and one or more base station antennas that are configured to provide two-way radio frequency (“RF”) communications with fixed and mobile subscribers (“users”) that are positioned throughout the cell. Most base station antennas are so-called “panel” antennas that include one or more columns of radiating elements that are mounted to extend forwardly from a reflector panel.

A WLAN refers to a network that operates in a limited area (e.g., within a home, store, campus, etc.) that wirelessly interconnects client devices (e.g., smartphones, computers, printers, etc.) with each other and/or with external networks such as the Internet. Most WLANs operate under the IEEE 802.11 standards, and such WLANs are commonly referred to as WiFi networks. A WiFi network includes one or more radio nodes or “access points” that are installed throughout a coverage area. Each access point comprises one or more radios and associated antennas. Client devices communicate with each other and/or with wired devices that are connected to the WiFi network through the access points. The access points may be connected to each other and/or to gateways that may be used to provide Internet access to the client devices. Most indoor access points include integrated antennas. However, access points that are deployed in large venues or that provide outdoor coverage often operate more akin to cellular base station antennas and include a separate panel antenna.

Base station antennas and panel WiFi antennas typically include phase-controlled arrays of radiating elements or “antenna arrays.” The radiating elements in an antenna array typically extend forwardly from a reflector panel, and are arranged in one or more vertically-extending columns when the antenna is mounted for use. RF signals output from a radio are divided into a plurality of sub-components that are fed to the individual radiating elements in the antenna array (or to groups thereof that are referred to as sub-arrays). The radiating elements generate a radiation pattern or “antenna beam” in response to the RF signal. Most base station antennas and panel WiFi antennas are “sector” antennas that include antenna arrays that are configured to generate directional radiation patterns that have high antenna gain in some directions and lower antenna gain in other directions. The radiation patterns generated by the antenna arrays of a sector antenna are designed to provide coverage to a pre-defined portion of a cell that is referred to as a “sector.” In one common configuration, a hexagonally-shaped cell is divided into three 120° sectors in the “azimuth” plane that are served by respective sector antennas. The azimuth plane refers to a horizontal plane (i.e., a plane that is parallel to the plane defined by the horizon) that bisects the antenna. The antenna arrays are designed to generate antenna beams having suitable Half Power Beamwidths (HPBW) in the azimuth plane to provide coverage to the sector (e.g., the antenna beam may have an azimuth HPBW of approximately 65°, which generally results in good coverage for a 120° sector). Reference will also be made herein to the elevation plane, which is a plane extending along a boresight pointing direction of one of the antenna arrays that is perpendicular to the azimuth plane. The boresight pointing direction of an antenna array refers to the direction where the gain of the antenna beam generated by the antenna array is the highest.

Early WiFi standards supported communication in the 2.401-2.484 GHz frequency range (herein “the 2.4 GHz frequency band”). Later WiFi standards supported communication in the 5.170-5.835 GHz frequency range (herein “the 5 GHz frequency band”). Most modern access points support communications in both the 2.4 GHz and 5 GHz frequency bands, and have a radio for each frequency band. Recently, the United States Federal Communications Commission voted to open spectrum in the 5.935-7.125 GHz frequency range, which is referred to herein as “the 6 GHz frequency band,” for use in WiFi applications, and many other countries are likewise in the process of allowing WiFi networks to operate in the 6 GHz frequency band.

### SUMMARY

Pursuant to embodiments of the present invention, switchable antennas are provided that comprise an RF port, an antenna array that includes at least a first column of radiating elements, a second column of radiating elements and a third column of radiating elements, and a feed network coupled between the RF port and the antenna array. The feed network includes a power divider that has an input that is coupled to the RF port, a first output that is coupled to the first and third columns of radiating elements through a phase shifter and a second output that is coupled to the second column of radiating elements.

The phase shifter may include a selectively switched phase shifter that switches between providing a phase shift or not providing a phase shift to RF signals received from the output of the power divider. The phase shifter may include an inductive element that is configured to determine the phase shift when the phase shifter is selectively switched to provide the phase shift. The phase shifter may include a diode that is selectively switched to provide a phase shift or not provide the phase shift to the output of the power divider.

In some embodiments, the switchable antenna may further include an inductive element that is in parallel with the diode and is configured determine an amount of the phase shift when the phase shifter is selectively switched to provide the phase shift. The antenna array may include a total of three columns of radiating elements, and wherein the power divider may include a 1×2 power divider that provides half of an RF energy input thereto to the phase shifter and half of the RF energy to the second column of radiating elements. The second column of radiating elements may be positioned between the first and third columns of radiating elements. The power divider may include a first power divider, the feed network further includes a second power divider that has an input that is coupled to an output of the phase shifter, and the second power divider includes a first output that is coupled to the first column of radiating elements and a second output that is coupled to the third column of radiating elements.

In some embodiments, the second power divider may include a 1×2 power divider that provides half of an RF energy input thereto to the first column of radiating elements and half of the RF energy to the third column of radiating elements. The second column of radiating elements is between the first column of radiating elements and the third column of radiating elements. The pattern shaping elements may be positioned adjacent at least some of the radiating elements in both the first column of radiating elements and the third column of radiating elements, the pattern shaping elements configured to portions of the RF energy emitted by the first column of radiating elements and the third column of radiating elements toward a center of a coverage area for the antenna array.

In some embodiments, the switchable antenna may further include a first impedance matching block coupled to the first output of the power divider and a second impedance matching block coupled to the second output of the power divider. The first and second impedance matching blocks have equal but opposite imaginary components.

In some embodiments, the power divider may include a first power divider that receives first frequency band signals and a second power divider that receives second frequency band signals. A first diplexer may be between the first power divider and the phase shifter, and a second diplexer may be between the second power divider and the second column of radiating elements.

Pursuant to embodiments of the present invention, switchable antennas are provided that comprise an RF port, an antenna array that includes at least a first column of radiating elements, a second column of radiating elements and a third column of radiating elements, and a feed network coupled between the RF port and the antenna array. The feed network includes a phase shifter. The first and third columns of radiating elements are coupled to the RF input port via a greater number of power dividers than the second column of radiating elements.

In some embodiments, a first power divider having a first output that is coupled to an input of the phase shifter and a second output that is coupled to the second column of radiating elements, and a second power divider whose input is coupled to an output of the phase shifter and a first output that is coupled to the first column of radiating elements and a second output that is coupled to the third column of radiating elements. The phase shifter may include a selectively switched phase shifter that switches between providing a phase shift or not providing a phase shift to RF signals received from the output of the first power divider. The phase shifter may include an inductive element that is configured to determine an amount of the phase shift when the phase shifter is selectively switched to provide the phase shift. The phase shifter may include a diode in parallel with an inductance.

In some embodiments, antenna array includes a total of three columns of radiating elements. The first power divider may include a 1×2 power divider that provides half of an RF energy input thereto to the phase shifter and half of the RF energy to the second column of radiating elements. The second power divider may include a 1×2 power divider that provides half of an RF energy input thereto to the first column of radiating elements and half of the RF energy to the third column of radiating elements.

Pursuant to embodiments of the present invention, switchable antennas are provided that comprise an RF port, an antenna array that includes at least a first column of radiating elements, a second column of radiating elements and a third column of radiating elements, and a feed network coupled between the RF port and the antenna array. The feed network may include a first power divider that has an input that is coupled to the RF port, a first output that is coupled to a phase shifter and a second output that is coupled to the second column of radiating elements, and a second power divider that has an input that is coupled to the phase shifter, a first output that is coupled to the first column of radiating elements and a second output that is coupled to the third column of radiating elements.

In some embodiments, the phase shifter may include a selectively switched phase shifter that switches between providing a phase shift or not providing a phase shift to RF signals received from the output of the first power divider. The phase shifter may include an inductive element that is configured to determine the phase shift when the phase shifter is selectively switched to provide the phase shift. The phase shifter may include a diode that is selectively switched to provide a phase shift or not provide the phase shift to the output of the first power divider.

In some embodiments, the switchable antenna may further include an inductive element that is in parallel with the diode and is configured determine an amount of the phase shift when the phase shifter is selectively switched to provide the phase shift. The antenna array includes a total of three columns of radiating elements. The first power divider may include a 1×2 power divider that provides half of an RF energy input thereto to the phase shifter and half of the RF energy to the second column of radiating elements, and the second power divider may include a 1×2 power divider that provides half of an RF energy input thereto to the first column of radiating elements and half of the RF energy to the third column of radiating elements.

### BRIEF DESCRIPTION OF THE DRAWINGS

FIG. 1 is an azimuth plot of a typical 90° sector antenna beam.

FIG. 2 is an azimuth plot of a typical high gain antenna beam.

FIG. 3 is a schematic front view of a panel antenna that can generate the antenna beam shown in FIG. 1.

FIG. 4 is a schematic front view of a panel antenna that can generate the antenna beam shown in FIG. 2.

FIG. 5 is a schematic front view of a switchable antenna according to embodiments of the present invention with the radome thereof removed.

FIGS. 6A and 6B are block diagrams of feed networks of the antenna of FIG. 5 for a 6 GHz frequency single-band case and a 2.4 GHz and 5 GHz dual-band case, respectively.

FIG. 7 is a block diagram of a portion of the feed network that includes a power divider and a phase change circuit, according to various embodiments.

FIG. 8 is a block diagram of a feed network for dual band operation of the antenna of FIG. 5.

FIG. 9 is a block diagram of a feed network for dual band operation with circuit diagrams of the power dividers, according to various embodiments.

FIG. 10 is a circuit diagram of a 6 GHz power divider with a phase shifter, and illustrates the DC path for the feed network, according to various embodiments.

FIG. 11 illustrates phase difference of signals in the 6 GHz frequency band when the diode of the phase change circuit of FIG. 9 is turned on.

FIG. 12 illustrates phase difference of signals in the 6 GHz frequency band when the diode of the phase change circuit of FIG. 9 is turned off.

FIG. 13 is a circuit diagram of a one-stage Wilkinson power divider circuit with phase change, according to various embodiments.

FIG. 14A is a graph that illustrates the phase difference of signals in the 6 GHz frequency band when the diode of the circuit of FIG. 13 is turned off.

FIG. 14B is a graph that illustrates the phase difference of signals in the 6 GHz frequency band when the diode of the circuit of FIG. 13 is turned on.

FIG. 15 illustrates example phases of RF signals at various elements in the antenna array, according to various embodiments.

FIGS. 16 to 19 illustrate RF radiation patterns of sector antennas at various phases, according to various embodiments.

Like reference numerals refer to corresponding parts throughout the drawings. Moreover, multiple instances of the same part may be designated by a common prefix separated from an instance number by a dash.

### DETAILED DESCRIPTION

While most sector antennas are designed to provide coverage to 90° or 120° sectors in the azimuth plane, there are some applications where narrower coverage areas are desirable. For example, in cellular communications systems, antennas having antenna arrays that generate antenna beams having azimuth HPBWs that are much narrower than 65° are often used to provide coverage to bridges, tunnels or long straight stretches of highway. Since the antenna beams are narrower in the azimuth plane (i.e., since the RF energy is concentrated into a smaller area in the azimuth plane), these antennas have higher gain and hence may support higher throughputs. In large venue and outdoor WiFi applications, the “cells” may be sub-divided into more than three sectors (e.g., six, nine or twelve sectors), and thus the antenna arrays in these WiFi antennas may be configured to produce antenna beams having much narrower azimuth beamwidths. In order to generate antenna beams having narrower azimuth beamwidths, antenna arrays are provided that include multiple columns of radiating elements that are all coupled to the same radio port, as the use of multiple columns increases the size or “aperture” of the antenna in the azimuth plane, which in turn acts to narrow the beamwidth of the generated antenna beams in the azimuth plane. The narrower antenna beams generated by these antenna arrays again have higher gain, and hence can provide coverage at greater distances from the antenna and/or may support higher throughput. Herein, antennas having antenna arrays that are configured to generate antenna beams having wider azimuth HPBWs that are designed to provide coverage to a relatively large sector (a sector spanning about 90° or more in the azimuth plane) are referred to as “sector antennas,” and the resultant antenna beams are referred to as “sector antenna beams.” Antennas having antenna arrays that are configured to generate antenna beams having much narrower azimuth HPBWs are referred to herein as “high gain antennas” and the resultant antenna beams are referred to as “high gain antenna beams.”

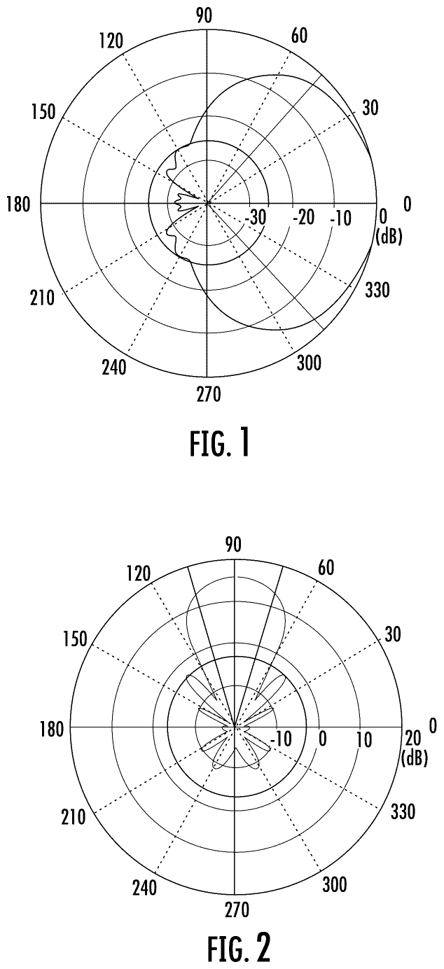

FIGS. 1 and 2 are so-called azimuth plots that respectively illustrate a typical 90° sector antenna beam and a typical high gain antenna beam. Antenna beams are three-dimensional radiation patterns. An azimuth plot refers to a horizontal cross-section taken through the three-dimensional radiation pattern at the elevation angle where the gain of the antenna beam is a maximum. Thus, an azimuth plot illustrates the gain of the antenna beams as a function of angle from the boresight pointing direction of the antenna for the elevation angle where the gain of the antenna beam is at a maximum.

As shown in FIG. 1, the sector antenna beam has a wide azimuth beamwidth, providing almost constant gain over the range of −/+30° in the azimuth plane. The gain falls by about 3 dB from peak gain at about −/+45°, and drops off rapidly at azimuth angles exceeding −/+60°. These characteristics allow the antenna beam to provide good coverage throughout most of a 90° sector (with gain, and hence performance, reduced some at the outer edges of the sector), while reducing the extent to which the antenna beam emits radiation into neighboring sectors, where such radiation will appear as interference.

As shown in FIG. 2, the high gain antenna beam has an azimuth HPBW of about 30°, and hence will provide good coverage in a 45° sector. Moreover, the gain drops off very quickly beyond azimuth angles exceeding −/+30°, which further reduces the extent to which the antenna beam emits radiation into neighboring coverage areas.

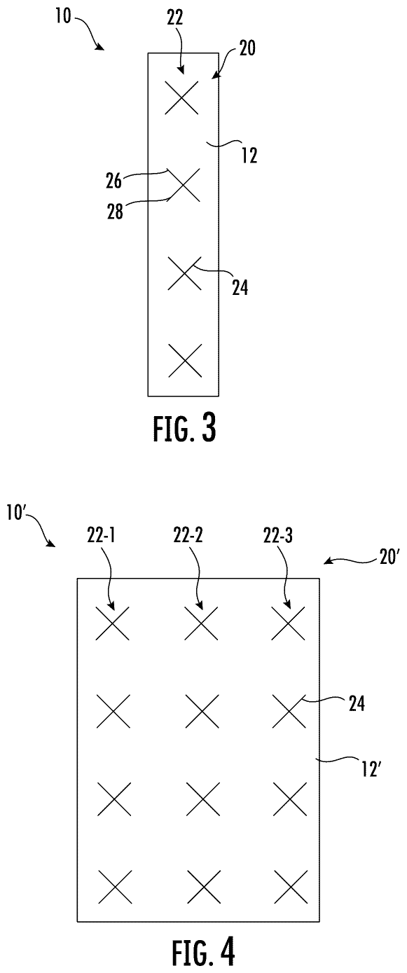

FIG. 3 is a schematic front view of a panel antenna 10 that can generate the antenna beam shown in FIG. 1. As shown in FIG. 3, the antenna 10 includes an antenna array 20 that comprises a single vertically-extending column 22 of radiating elements 24. The radiating elements 24 are mounted to extend forwardly from a reflector 12. A wide variety of different types of radiating elements 24 may be used including, for example, dipole, patch, monopole, horn and slot radiating elements, to name a few, or specific implementations of such radiating elements such as yagi or log periodic dipole radiating elements. The radiating elements 24 may comprise single polarization radiating elements that include a single radiator that emits radiation at a given polarization, or may comprise dual-polarized radiating elements that include first and second radiators that emit radiation at orthogonal polarizations. When dual-polarized radiating elements 24 are used, the antenna array 20 may be connected to a pair of radios, and will generate a pair of antenna beams, namely one at each polarization. Since the polarizations are orthogonal, they exhibit low-levels of cross-interference, and hence in some cases the use of dual-polarized radiating elements 24 may allow nearly a doubling in the capacity supported by the antenna. In other cases, the radio may instead simply transmit and receive RF signals through whichever polarization radiators provide better performance. In the example of FIG. 3, the radiating elements are illustrated as being slant −/+45° cross-dipole radiating elements 24 that each include a first dipole radiator 26 that emits radiating having a slant −45° polarization and a second dipole radiator 28 that emits radiating having a slant +45° polarization.

Each radiating element 24 may be designed to generate an individual or “element” radiation pattern having HPBWs of about 45° in both the azimuth and elevation planes. Since all of the radiating elements 24 are aligned in a vertically-extending column, the azimuth HPBW of the antenna beam generated by the antenna array 20 will be equal to the element radiation pattern. Thus, the azimuth HPBW of antenna array 20 will be about 45°, which will provide good coverage throughout the 90° sector. Since multiple radiating elements 24 are included in antenna array 20, the “aperture” of the array is increased in the elevation plane. By properly adjusting the phase of the sub-components of the RF signal that are fed to the individual radiating elements 24, this increased aperture in the elevation plane may be used to concentrate the RF energy in the elevation plane into a smaller area (so that the resultant antenna beam will have an elevation HPBW of less than 45°), thereby increasing the gain of the antenna beam. The more radiating elements 24 added to column 22 (where the radiating elements 24 are spaced apart from each other by a distance that is selected to control other parameters of the radiation pattern, such as off-axis grating lobes), the more the elevation HPBW is reduced, and the higher the gain of the antenna beam.

FIG. 4 is a schematic front view of a panel antenna 10′ that can generate the antenna beam shown in FIG. 2. As shown in FIG. 4, the antenna 10′ includes an antenna array 20′ that includes three columns 22-1, 22-2, 22-3 of radiating elements 24. The radiating elements 24 are mounted to extend forwardly from a reflector 12′. In FIG. 4, the radiating elements 24 are schematically shown as being cross dipole radiating elements, although any type of radiating element may be used. Each radiating element 24 may be designed to generate an element radiation pattern having HPBWs of about 45° in both the azimuth and elevation planes. Since each column 22 includes multiple radiating elements 24, the “aperture” of antenna array 20′ is increased in the elevation plane in the exact same manner as antenna array 20 of FIG. 3. Moreover, all three columns 22-1, 22-2, 22-3 are coupled to the same radio, and hence the aperture of the array is also increased in the azimuth plane as compared to antenna array 20 of FIG. 3. By properly adjusting the phase of the sub-components of the RF signal that are fed to the individual radiating elements 24 in all three columns 22, the RF energy emitted by antenna array 20′ may be concentrated in both the azimuth and elevation planes, significantly increasing the gain of the resultant antenna beam. The gain can be further increased by increasing the number of columns 22 of radiating elements 24 and/or by increasing the number of radiating elements 24 included in each column 22.

Conventionally, antenna manufacturers provide a first antenna having the design of FIG. 3 to provide a sector antenna and provide a second antenna having the design of FIG. 4 to provide a high gain antenna. Pursuant to embodiments of the present invention, switchable antennas are provided that may operate either as a sector antenna or as a high gain antenna. The switchable antennas according to embodiments of the present invention may be configured, for example, at the factory or on-site at the time of installation, to operate as either a sector antenna or a high gain antenna. One problem with including switching capabilities in an antenna is that switching networks include losses. These losses reduce the gain of the antenna. The switchable antennas according to embodiments of the present invention can switch between a high gain mode and a lower gain mode with low loss.

The switchable antennas according to embodiments of the present invention include a feed network that couples at least one RF connector port of the antenna to an antenna array. A multi-column array can be selectively switched between two different column phases to generate either a sector antenna beam or a high gain antenna beam. This selective switching is accomplished by having a feed network that includes a phase shifter. The phase shifter is selectively shifted between a narrow beam mode and a sector mode for the antenna array.

Thus, the antennas according to embodiments of the present invention may be switchable between a high gain mode and a lower gain (sector) mode, yet have relatively small insertion losses. This may allow an antenna manufacturer to stock a single panel antenna that can be used in first and second modes that are associated with first and second applications.

The switchable antennas according to embodiments of the present invention may be switchable between a high gain mode and a lower gain mode. This selective switching between the high gain mode and the lower gain mode is accomplished by having a feed network that includes a power divider that has one output that is coupled to outer columns of radiating elements through a phase shifter and has another output that is coupled to a center column of radiating elements. The phase shifter is selectively shifted between a narrow beam mode and a sector mode for the antenna array by including a phase shift to RF signals received from the output of the power divider for the sector mode and not including the phase shift for the narrow beam mode.

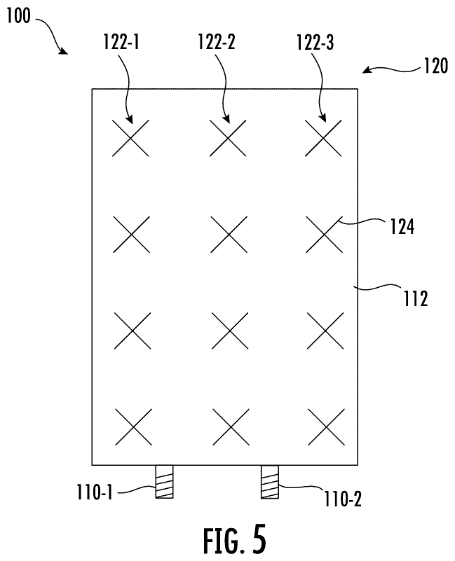

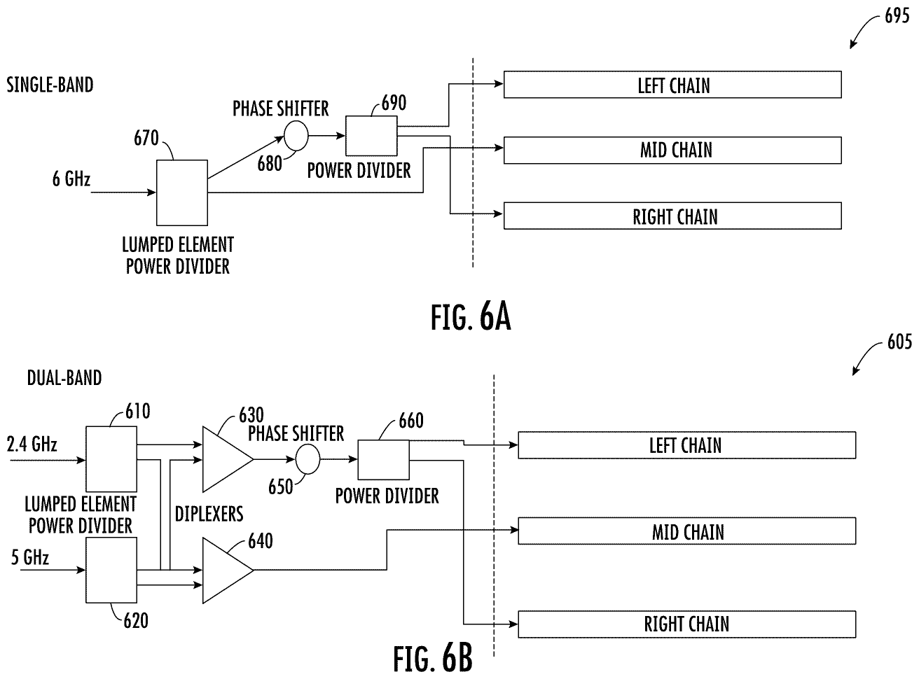

FIG. 5 is a schematic front view of a switchable antenna 100 according to certain embodiments of the present invention with a radome thereof removed.

Referring to FIG. 5, the antenna 100 includes a pair of RF ports 110-1, 110-2. The antenna 100 may include a conventional housing (not shown) such as, for example, a tubular radome with bottom and top end caps, that protects the electronic circuits of antenna 100 from environmental elements. The RF ports 110-1, 110-2 may extend through the housing, and may be used to connect antenna 100 to an external radio via, for example, coaxial cables. A wide variety of RF ports may be used, including threaded connector ports, blind mate ports, push-on connector ports and the like. In some cases, the radio (or radios) may be internal to antenna 100, in which case the RF ports 110-1, 110-2 are the connections between the feed networks of antenna 100 and the outputs of the radios.

As is further shown in FIG. 5, antenna 100 includes an array 120 of radiating elements 124. The array 120 includes three columns 122-1 through 122-3 of radiating elements 124. The radiating elements 124 extend outwardly from a reflector 112 that may act as a ground plane for the radiating elements 124. The radiating elements 124 may each comprise slant −/+45° cross-dipole radiating elements, although any type of radiating element may be used. Each radiating element 124 may, in an example embodiment, be designed to generate an element radiation pattern having HPBWs of about 45° in both the azimuth and elevation planes. A feed network 130 (not shown) connects the RF ports 110 to the radiating elements 124 of antenna array 120.

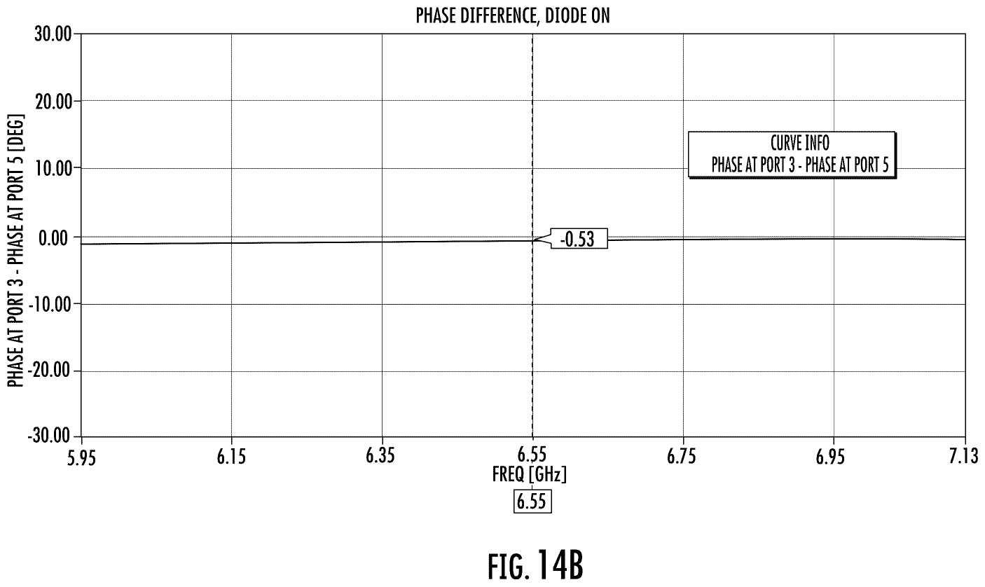

FIGS. 6A and 6B are block diagrams of feed networks of the antenna of FIG. 5 for the single-band and dual-band cases, respectively. Referring to FIG. 6A, the feed network for the antenna 100 of FIG. 5 is shown for the case where the antenna 100 is a single-band antenna (e.g., where the antenna is designed to transmit and receive RF signals in the 6 GHz frequency band). A first power divider 670 may receive a 6 GHz RF signal from the radio and split this RF signal into first and second sub-components. The first sub-component of the 6 GHz RF signal is passed by the first output of the first power divider 670 to the middle column of radiating elements of the antenna array 695. The second sub-component of the 6 GHz RF signal is passed by the second output of the first power divider 670 to a phase shifter 680 that provides a phase shift to the RF signals. The output of the phase shifter is coupled to a second power divider 690. The first output of the second power divider 690 is coupled to the left column of radiating elements of the antenna array 695, and the second output of the second power divider 690 is coupled to the right column of radiating elements of the antenna array 695. The first and second power dividers 670 and 690 may both be equal power dividers in some embodiments. For example, the second power divider 690 may be a Wilkinson power divider, as shown in FIG. 14. In some embodiments, a first impedance matching block may be coupled to the first output of the power divider 690 and a second impedance matching block may be coupled to the second output of the power divider 690. The first and second impedance matching blocks may have equal but opposite imaginary components for proper operation of the antenna array 695. As a non-limiting example, when the first and second power dividers 670 and 690 are equal power dividers, the left and right columns of radiating elements of the antenna array 695 may each receive 25% of the power of an input 6 GHz RF signal and the middle column of radiating elements of the antenna array 695 may receive 50% of the power of the input 6 GHz RF signal. However, other ratios for the power dividers may be used, but the left and right columns of radiating elements will usually receive the same power levels. Phase shifter 680 may be a variable phase shifter that selectively phase shifts or does not phase shift (i.e., a low phase change close to 0°). A low phase change close to 0° phase shift produces a narrowband beam from the antenna array 695. The amount of phase shift that is applied when the phase shifter applies a phase shift may be selected to widen the azimuth HPBW for coverage as much as possible for a 120° sector in the azimuth plane. Although the single band antenna of FIG. 6A is shown as operating in the 6 GHz band as a non-limiting example, this single band antenna may be designed to operate in the 2.4 GHz or the 5 GHz frequency bands.

Referring to FIG. 6B, the feed network for the antenna 100 of FIG. 5 is shown for the case where the antenna 100 is a dual-band antenna (e.g., where the antenna is designed to transmit and receive RF signals in both the 2.4 GHz and 5 GHz frequency bands). In this case, the radiating elements 124 shown in FIG. 5 may be dual-band radiating elements that can transmit and receive signals in both the 2.4 GHz and 5 GHz frequency bands.

As shown in FIG. 6B, a 2.4 GHz RF signal may be input to a first power divider 610. The first output of the first power divider 610 is coupled to a first diplexer 630 and the second output of the first power divider 610 is coupled to a second diplexer 640. Similarly, a 5 GHz RF signal may be input to a second power divider 620. The first output of the second power divider 620 is coupled to the first diplexer 630 and the second output of the second power divider 620 is coupled to the second diplexer 640. The output of the first diplexer 630 is input to phase shifter 650. Phase shifter 650 may be a variable shifter that selectively phase shifts or does not phase shift (i.e., phase change of about 0°). The output of phase shifter 650 is input to a third power divider 660. The first output of the third power divider 660 is coupled to the left column of radiating elements of the antenna array 605, and the second output of the third power divider 660 is coupled to the right column of radiating elements of the antenna array 605. The output of the second diplexer 640 is fed to the middle column of radiating elements of the antenna array 605. For implementation, as a non-limiting example, first power divider 610 and/or the second power divider 620 may be implemented using L-C circuits, whereas third power divider may be implemented using traces on a board. When the phase shifter 650 applies a 0° phase shift, the RF signals that are input to the antenna (i.e., the 2.4 GHz and 5 GHz RF signals) are split into three in-phase sub-components that are fed to the three columns of radiating elements of the antenna array 605. Since the three sub-components are in-phase, the antenna beams generated by the three columns of radiating elements of the antenna array 605 will constructively combine to generate a high gain antenna beam that has a significantly narrowed azimuth HPBW. In contrast, when the phase shifter 650 applies a non-zero phase shift, the sub-components of the RF signals that are input to the outer two columns of the antenna array 605 are out-of-phase with respect to the sub-components of the RF signals that are input to the middle column of the antenna array 605, which results in a widening of the azimuth antenna HPBW of composite antenna beam. The amount of phase shift that is applied when the phase shifter applies a phase shift may be selected to widen the azimuth HPBW for coverage as much as possible for a 120° sector in the azimuth plane in an example embodiment.

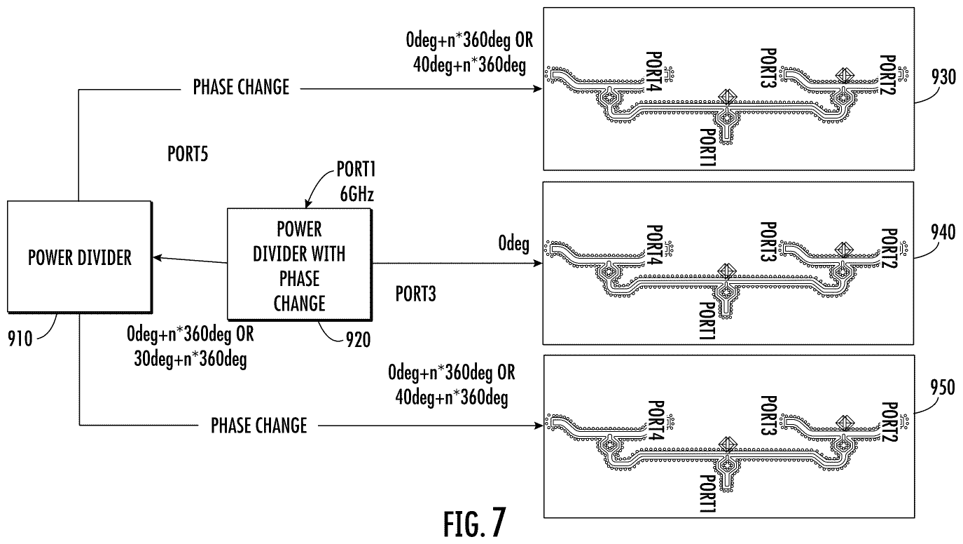

FIG. 7 is a block diagram of a portion of the feed network that includes a first power divider 910 that has an integrated phase change circuit and a second power divider 910, according to various embodiments. First power divider 910 of FIG. 7 may correspond to the second power divider 690 of FIG. 6A and the power divider with an integrated phase shift circuit 920 of FIG. 7 may correspond to first power divider 670 and phase shift circuit 680 of FIG. 6A. WiFi signals in the 6 GHz frequency band are input at port 1 of the first power divider with the integrated phase shift circuit power divider 920. The power levels of the WiFi signals in the 6 GHz frequency band are divided such that some of the signal (e.g., half the signal strength) is fed to a middle column 940 of an antenna array from port 3. The remainder of the signal is selectively phase shifter (e.g., it is not phase shifter at all, or phase shifted by 30°) and is fed to the second power divider 910. The second power divider 910 splits the signals input thereto and feeds half the RF energy to the right column 930 of radiating elements and the other half of the RF energy to the left column 950 of radiating elements. The signals fed to the middle column 940 may have 0° of phase shift and the signals fed to the left and right columns 930, 950 may each have either a 0° phase shift or a 30° phase shift in this example.

The circuit of FIG. 7 may be functionally equivalent to the circuit of FIG. 6A, with the only difference between the two circuits being that in the circuit of FIG. 7 the first power divider and the phase shift circuit are implemented as a single circuit element 920, whereas in the circuit of FIG. 6A power divider 690 and phase shift circuit 680 are implemented as separate elements. Thus, the circuit of FIG. 7 will operate in the same fashion as the circuit of FIG. 6A, and hence description of the operation of the circuit of FIG. 7 will be omitted.

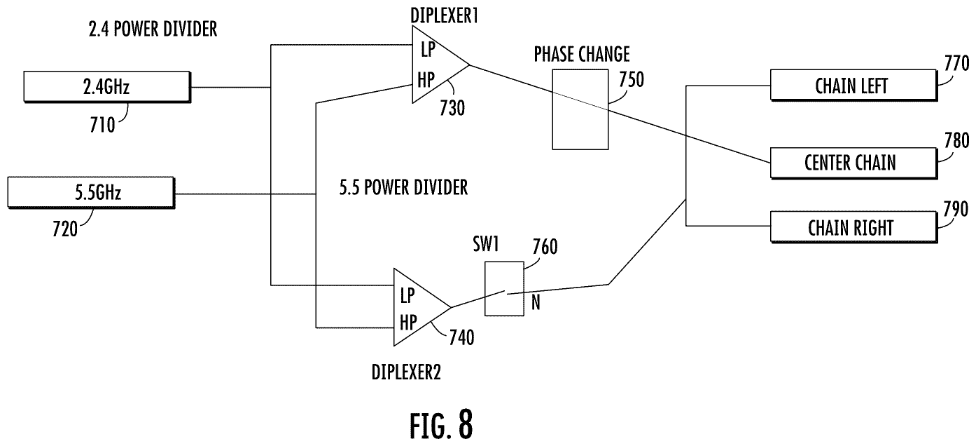

FIG. 8 is a block diagram of an alternative feed network for the antenna 100 of FIG. 5 for the case where the antenna 100 is a dual-band antenna (e.g., where the antenna is designed to transmit and receive RF signals in both the 2.4 GHz and 5 GHz frequency bands), according to some embodiments. A 2.4 GHz input signal and a 5.5 GHz input signal are input to a first diplexer 730 and a second diplexer 740. The output of the first diplexer 730 is fed to a phase change element 750, which feeds the center column 780. The phase change element 750 provides a phase change to the RF signals that are input to the center column 780 of the antenna array. The phase change element 750 may include a delay element such as traces on the feed board or may include an L-C circuit. The output of the second diplexer 740 is fed to the switch 760 which feeds both the left column 770 and the right column 780 of the antenna array. Switch 760 is used to select between operation of the antenna in the narrow beam mode vs. the sector mode. In the sector mode, the switch 760 disconnects the signal path to the left column 770 and the right column 790. However, in the sector mode, half the RF signal power may be wasted or dissipated at the switch, since the switch effectively disconnects the left column 770 and the right column 790 of the array antenna.

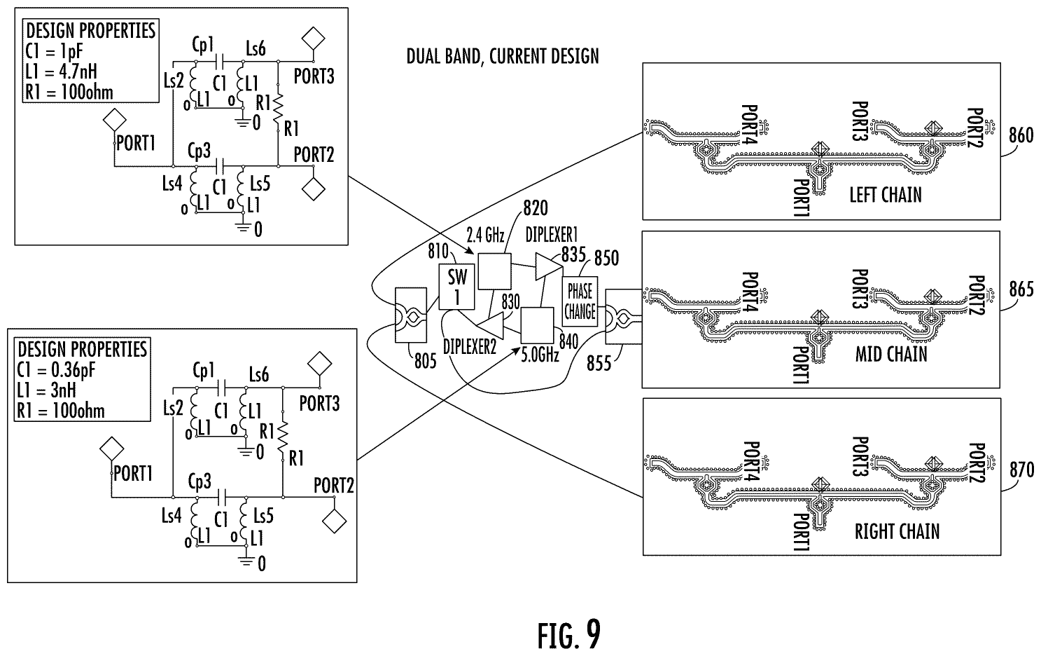

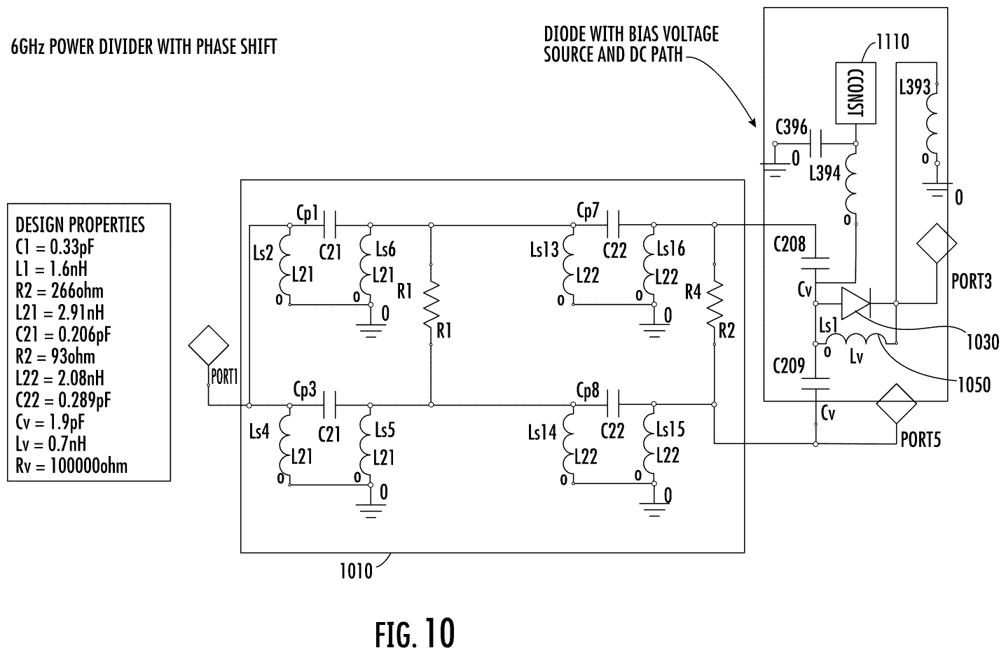

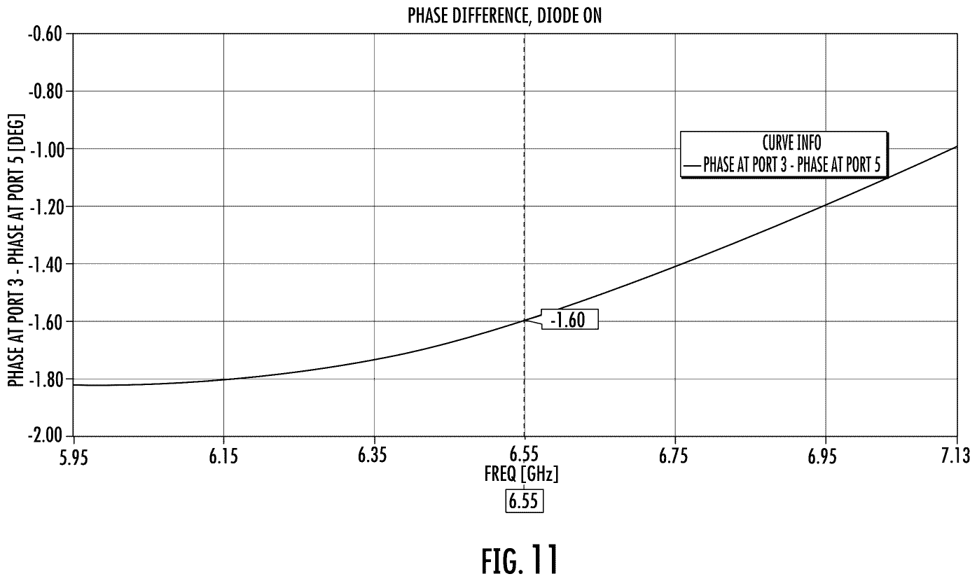

FIG. 9 is a block diagram of another alternative feed network for the antenna 100 of FIG. 5 for the case where the antenna 100 is a dual-band antenna, according to various embodiments. A first power divider 820 is coupled to a 2.4 GHz RF input. The first output of the first power divider 820 is coupled to a first diplexer 835. The second output of the first power divider 820 is coupled to a second diplexer 830. Similarly, a second power divider 840 is coupled to a 5 GHz RF input. The first output of the second power divider 840 is coupled to the first diplexer 835, and the second output of the second power divider 840 is coupled to the second diplexer 830. The output of the first diplexer 835 is coupled to a selective phase change circuit 850. The output of the selective phase change circuit 850 is coupled to a first input of a power combiner 855 (e.g., a Wilkinson power divider/combiner). The output of the power combiner 855 is coupled to the middle column 865 of radiating elements of the antenna array. The output of the second diplexer 830 is coupled to an input of a 1×2 switch 810. The first output of the 1×2 switch 810 is coupled to the second input of the power combiner 855. The second output of the 1×2 switch 810 is coupled to a third power divider 805 (here shown as a Wilkinson power divider). The first output of the third power divider is coupled to left column 860 of radiating elements of the antenna array, and the second output of the third power divider is coupled to right column 870 of radiating elements of the antenna array. The design of the feed network of FIG. 9 includes 1×2 switch 810 that is coupled to power combiner 855 in order to not waste power in the sector mode of operation of the feed network, unlike the embodiment described with respect to FIG. 8.

The circuit shown in FIG. 9 may operate as follows. A 2.4 GHz RF signal may be input to the first power divider 820, where it may be split into first and second sub-components that are passed to the respective first and second diplexers 835, 830. A 5 GHz RF signal may similarly be input to the second power divider 840, where it may be split into first and second sub-components that are also passed to the respective first and second diplexers 835, 830. The first diplexer 835 combines the first sub-components of the 2.4 GHz and 5 GHz RF signals and passes the combined first sub-components to the selective phase change circuit 850. The selective phase change circuit 850 may then either apply, or not apply, a predetermined phase shift to the combined first sub-components of the 2.4 GHz and 5 GHz RF signals, and passes the first sub-components to the first input of the power combiner 855. The second diplexer 830 combines the second sub-components of the 2.4 GHz and 5 GHz RF signals and passes the combined second sub-components to the 1×2 switch 810.

If the antenna is configured to operate as a sector antenna, the 1×2 switch 810 is set to output the RF signals input thereto to the first output thereof, which passes the second sub-components of the RF signals to the power combiner 855. The circuit is designed so that the second sub-components of the RF signals that are input to the power combiner 855 are in-phase with respect to the first sub-components of the RF signals that are input to the power combiner 855 (this may be done, for example, by configuring the phase shift circuit 850 to apply no phase change. The power combiner 855 combines the first and second sub-components of the RF signals and passes these combined RF signals to the middle column 865 of radiating elements. Since all of the RF energy is passed to a single (here the middle) column of radiating elements, the antenna will generate a sector antenna beam in this configuration.

If the antenna is configured to operate as a high gain antenna, the 1×2 switch 810 is set to output the RF signals input thereto to the second output thereof, which passes the second sub-components of the RF signals to the third power divider 805. The third power divider splits the second sub-components of the RF signals, passing half the RF energy to the left column 860 of radiating element and the other half of the RF energy to the right column 870 of radiating elements. The phase shift circuit 850 may be set to apply a phase shift so that the phase of the first sub-components of the RF signals that are fed to the middle column 865 of radiating elements are in-phase with the phases of the second sub-components of the RF signals that are fed to the outer columns 860, 870 of radiating elements. Since all three columns of radiating elements are fed in-phase signals, the antenna array may generate a high gain antenna beam having a narrowed azimuth HPBW in this configuration.

FIG. 10 is a circuit diagram of one possible implementation of the 6 GHz power divider with a phase shift circuit 920 of FIG. 7, according to various embodiments. The power divider with a phase shift circuit 920 may include a power divider circuit 1010 and a phase change circuit 1020. In this example embodiment, a two-stage power divider is illustrated. The first output of the power divider circuit 1010 is port 5 in FIG. 10, which is coupled to the middle column 1040 of the antenna array of FIG. 7. The phase change circuit may be implemented as a diode 1030 that is coupled in parallel with an inductor 1050. Diode 1030 is used a phase shift selective switch. The diode 1030 is turned on and off by a DC control signal, such that the circuit behaves as a shorted path through diode 1030 or as an inductance Lᵥ of inductor 1050. The second output of the power divider circuit (Port 3) is coupled to second power divider 910 of FIG. 7. Legacy designs had much insertion loss in the center path to the center column of the antenna array, but the design of FIG. 8 moves switches to the left and right paths and away from the center column, thus reducing the insertion loss of the feed network in the center path. Additionally, the loss at switch 760 of FIG. 8 in the left and right signal paths is not present in the design of FIG. 10. The insertion loss in this design with the LC circuit is <0.5 dB, which is primarily based on the inductive and capacitive components. For example, in a prototype, the insertion loss was about 3.5 dB for the entire center path in the legacy design. Furthermore, the inductor Lᵥ provides a phase variation for the signal that is provided to the power divider 910 of FIG. 7 for the left and right columns. Capacitors C208 and C209 help balance the different signal paths and provide DC blocking. Elements such as capacitor C396, inductors L393 and L394, and DC bias voltage source 1110 provide a DC selection signal to turn diode 1030 between the on and off states, according to various embodiments described herein.

FIG. 11 is a graph that illustrates the phase difference of signals in the 6 GHz frequency band when the diode of the phase change circuit of FIG. 10 is turned on. As shown, the amount of phase shift applied when the diode is turned on ranges from 1° to 1.8° (with a phase change of 1.6° at the center of the 6 GHz band) when the diode 1030 of FIG. 10 is on.

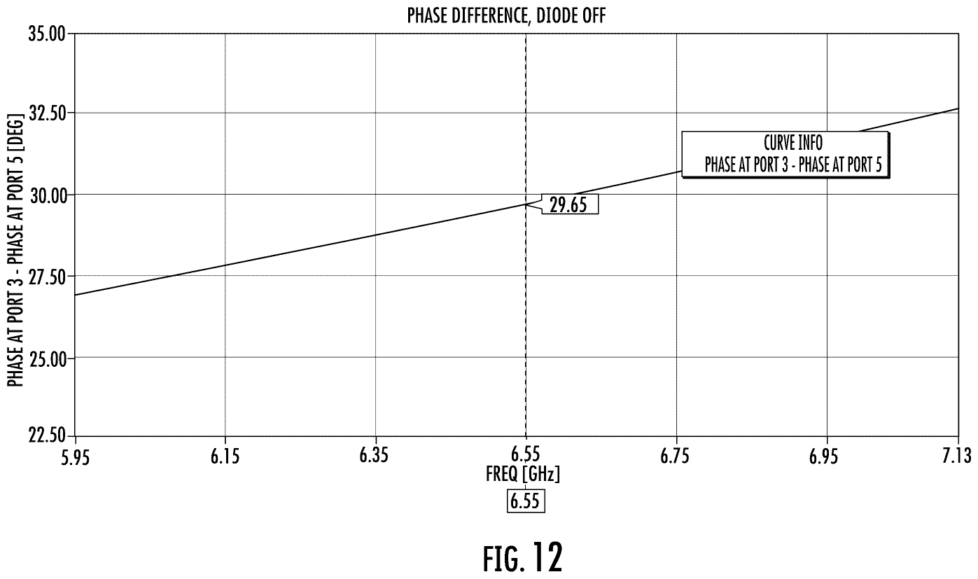

FIG. 12 is a graph that illustrates the phase difference of signals in the 6 GHz frequency band when the diode of the phase change circuit of FIG. 10 is turned off. As shown, the amount of phase shift applied when the diode is turned off ranges from about 27° to about 32.5° (with a phase change of 29.65° at the center of the 6 GHz band) when the diode 1030 of FIG. 10 is turned off.

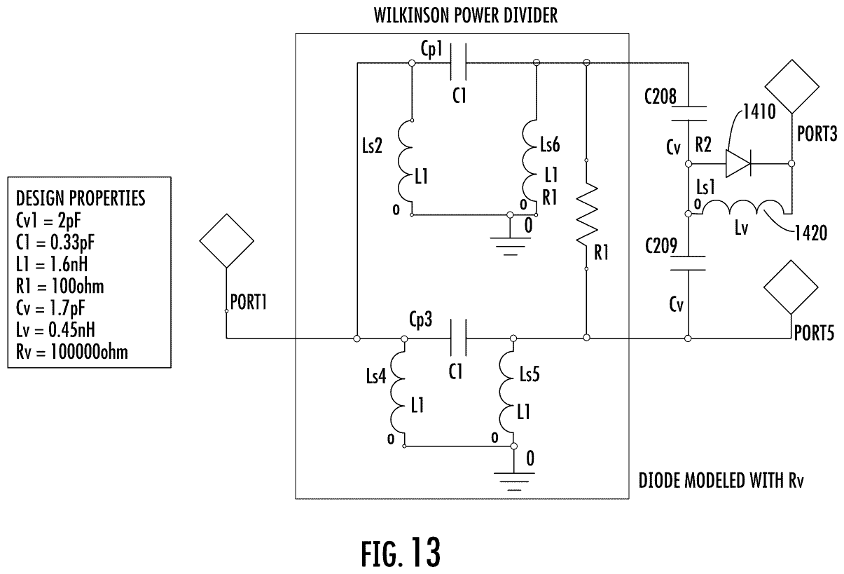

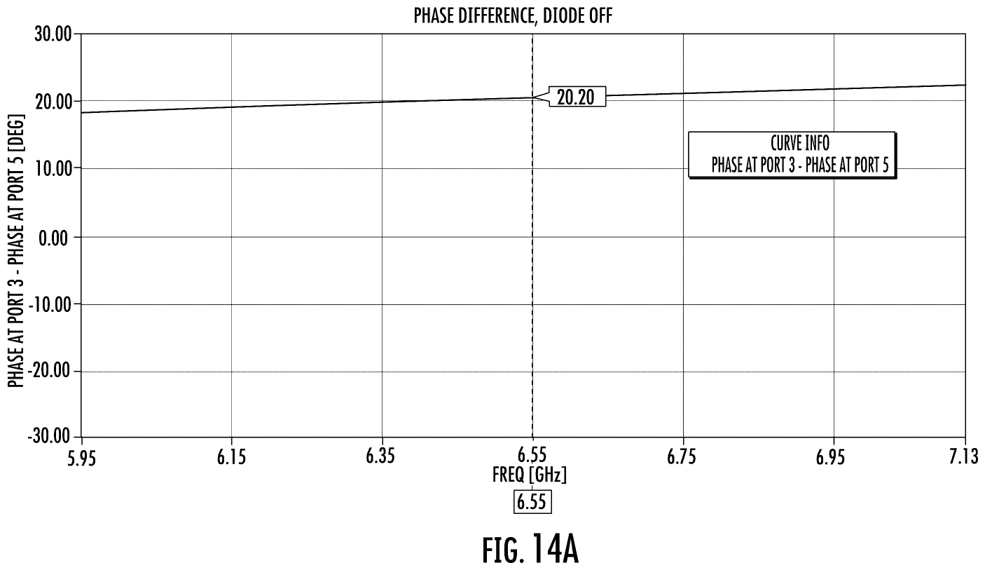

FIG. 13 is a circuit diagram of a Wilkinson power divider circuit for a one-stage power divider with phase change, according to various embodiments. For a single frequency band antenna, a one-stage power divider, such as a Wilkinson power divider may be used. The phase shift portion is similar to the dual-band case of FIG. 10 and may be implemented as a diode 1410 that is coupled in parallel with an inductor 1420. When the diode 1410 is turned on, RF signals will pass through the diode 1410 with essentially no phase shift. When the diode 1410 is turned off, RF signals will pass instead through the inductor 1420 which imparts the phase shift illustrated, for example, in FIG. 13.

FIG. 14A is a graph that illustrates the phase difference of signals in the 6 GHz frequency band when the diode of the circuit of FIG. 13 is turned off. As shown, the amount of phase shift applied when the diode is turned off is 20.20° at the center of the 6 GHz band when the diode 1410 of FIG. 13 is turned off.

FIG. 14B is a graph that illustrates the phase difference of signals in the 6 GHz frequency band when the diode of the circuit of FIG. 13 is turned on. As shown, the amount of phase shift applied when the diode is turned on is about 0.53° at the center of the 6 GHz band) when the diode 1410 of FIG. 13 is on.

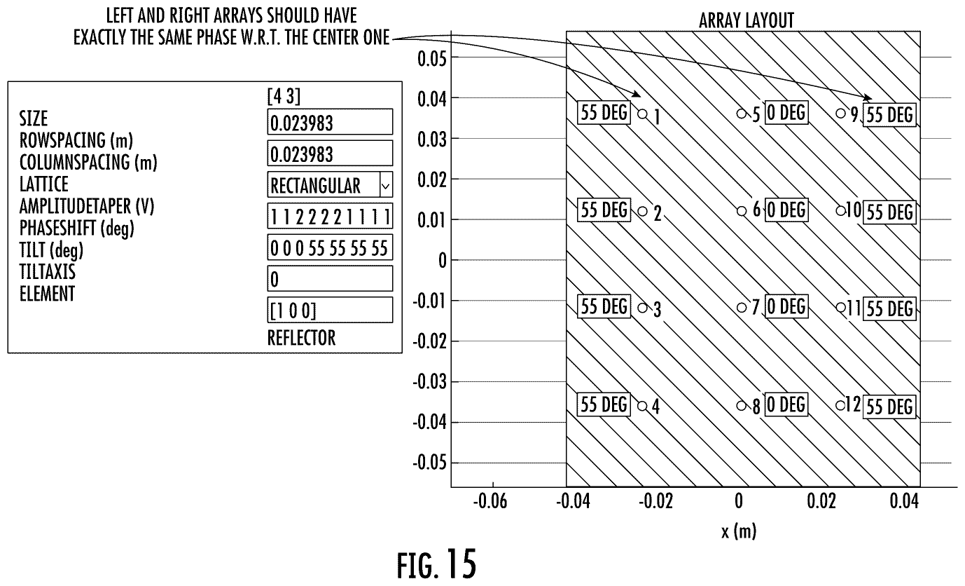

FIG. 15 illustrates example phases of RF signals at various elements in the antenna array, according to various embodiments. Referring to FIG. 15, an antenna array layout of antenna elements is illustrated. The left and right columns of radiating elements in this example have a phase shift of 55° at each radiating element, while the center column has a phase shift of 0° at each radiating element. This phasing of the sub-components of the RF signals that are fed to each radiating element in the array may be used to generate a sector antenna beam such as the antenna beam shown in FIG. 1.

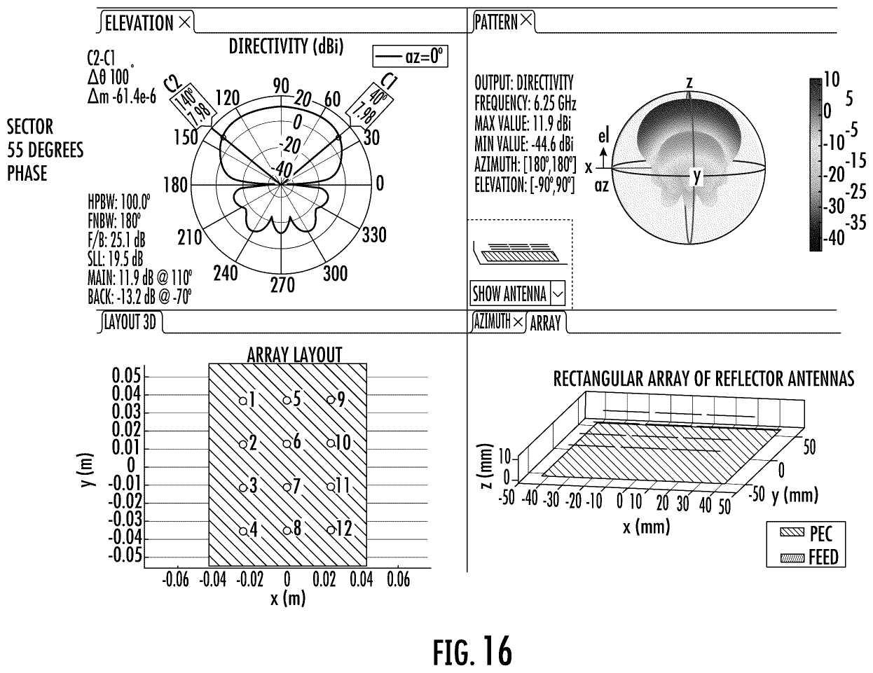

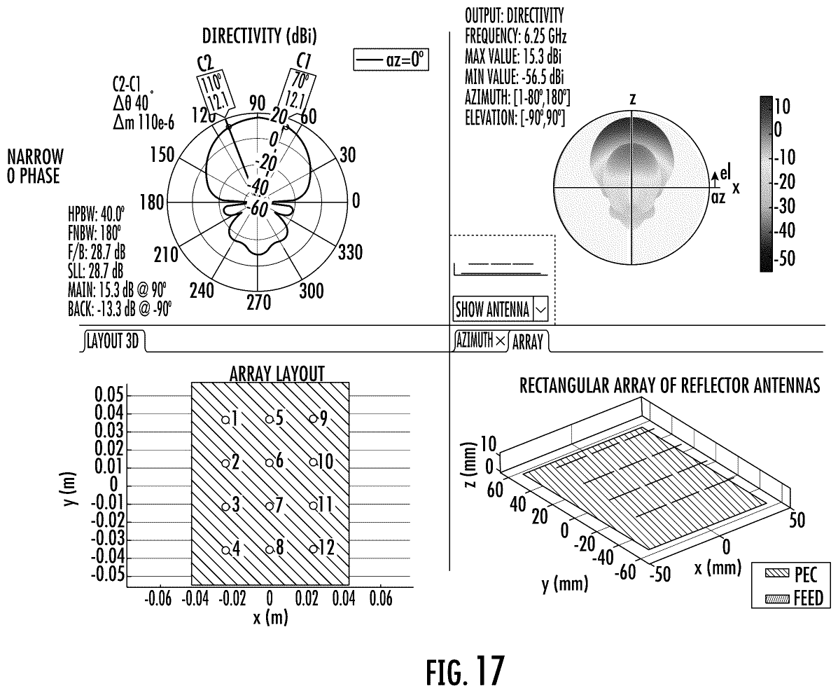

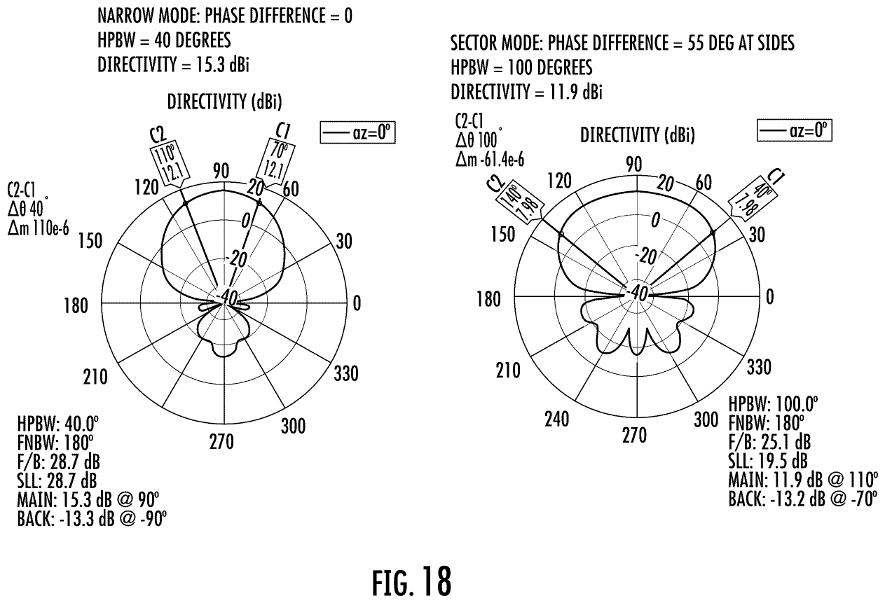

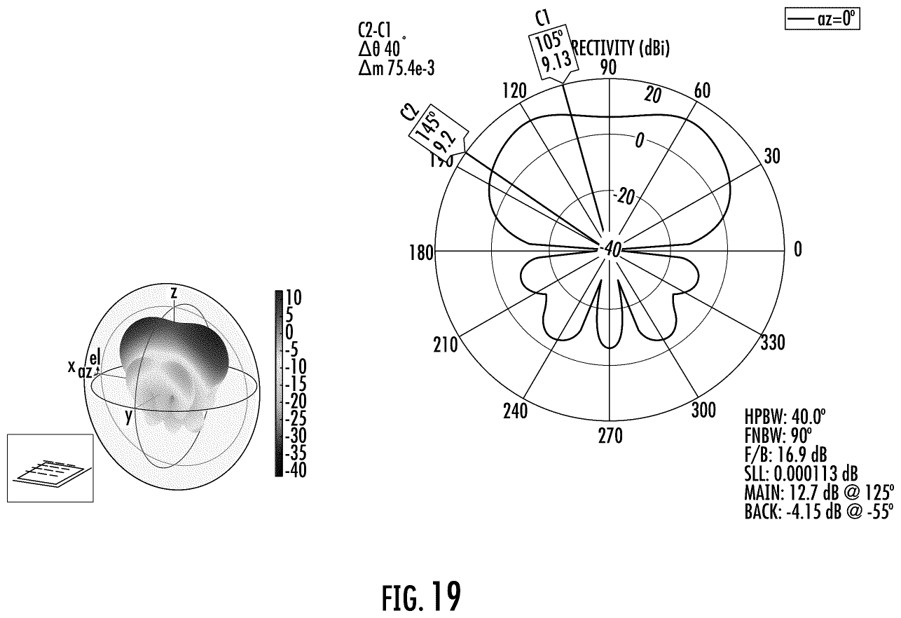

FIGS. 16 to 19 illustrate RF radiation patterns of sector and narrow antennas at various phases, according to various embodiments. By varying the inductance and capacitance values of circuit elements in the circuit of FIG. 10, it is possible to achieve a wide beamwidth such as with a 55° phase shift in FIG. 16 or to achieve a narrow beamwidth such as with a 0° phase shift in the example of FIG. 17. FIG. 18 is a side-by-side comparison of the beams in the narrow and sector modes. The sector beamwidth achieved is about 1000 in the sector mode example, and about 40° in the narrow mode example. FIG. 19 illustrates a case where the maximum gain of the antenna is at around 75° that is achieved by implementing an additional 90° phase shift of the signals in the feed network. The sector beamwidth achieved is about 40° in the example of FIG. 19.

It will be appreciated that many modifications may be made to the antennas described above without departing from the scope of the present invention. For example, the antennas can have more or fewer columns of radiating elements, and can include more or fewer radiating elements in each column. The antennas can be designed to cover different sized coverage areas in the azimuth plane. For example, in some embodiments, the antennas may be designed to cover 120° sectors in the azimuth plane when operating as a sector antenna.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

That which is claimed is:

1. A switchable antenna, comprising:
a radio frequency (“RF”) port;
an antenna array that includes at least a first column of radiating elements, a second column of radiating elements and a third column of radiating elements; and
a feed network coupled between the RF port and the antenna array,
wherein the feed network comprises a power divider that has an input that is coupled to the RF port, a first output that is coupled to the first and third columns of radiating elements through a phase shifter and a second output that is coupled to the second column of radiating elements.

2. The switchable antenna of claim 1, wherein the phase shifter comprises a selectively switched phase shifter that switches between providing a phase shift or not providing a phase shift to RF signals received from the output of the power divider.

3. The switchable antenna of claim 1, wherein the phase shifter comprises an inductive element that is configured to determine the phase shift when the phase shifter is selectively switched to provide the phase shift.

4. The switchable antenna of claim 1, wherein the phase shifter comprises a diode that is selectively switched to provide a phase shift or not provide the phase shift to the output of the power divider.

5. The switchable antenna of claim 4, further comprising:
an inductive element that is in parallel with the diode and is configured determine an amount of the phase shift when the phase shifter is selectively switched to provide the phase shift.

6. The switchable antenna of claim 1, wherein the antenna array includes a total of three columns of radiating elements, and wherein the power divider comprises a 1×2 power divider that provides half of an RF energy input thereto to the phase shifter and half of the RF energy to the second column of radiating elements.

7. The switchable antenna of claim 6, wherein the second column of radiating elements is positioned between the first and third columns of radiating elements.

8. The switchable antenna of claim 1, wherein the power divider comprises a first power divider,
wherein the feed network further comprises a second power divider that has an input that is coupled to an output of the phase shifter, and
wherein the second power divider includes a first output that is coupled to the first column of radiating elements and a second output that is coupled to the third column of radiating elements.

9. The switchable antenna of claim 8, wherein the second power divider comprises a 1×2 power divider that provides half of an RF energy input thereto to the first column of radiating elements and half of the RF energy to the third column of radiating elements.

10. The switchable antenna of claim 1, wherein the second column of radiating elements is between the first column of radiating elements and the third column of radiating elements.

11. The switchable antenna of claim 1, wherein pattern shaping elements are positioned adjacent at least some of the radiating elements in both the first column of radiating elements and the third column of radiating elements, the pattern shaping elements configured to redirect portions of the RF energy emitted by the first column of radiating elements and the third column of radiating elements toward a center of a coverage area for the antenna array.

12. The switchable antenna of claim 1, further comprising:
a first impedance matching block coupled to the first output of the power divider and a second impedance matching block coupled to the second output of the power divider,
wherein the first and second impedance matching blocks have equal but opposite imaginary components.

13. The switchable antenna of claim 1, wherein the power divider comprises a first power divider that receives first frequency band signals and a second power divider that receives second frequency band signals,
wherein a first diplexer is between the first power divider and the phase shifter, and
wherein a second diplexer is between the second power divider and the second column of radiating elements.

14. A switchable antenna, comprising:
a radio frequency (“RF”) input port;
an antenna array that includes at least a first column of radiating elements, a second column of radiating elements and a third column of radiating elements; and
a feed network coupled between the RF port and the antenna array,
wherein the feed network comprises a phase shifter, and
wherein the first and third columns of radiating elements are coupled to the RF input port via a greater number of power dividers than the second column of radiating elements.

15. The switchable antenna of claim 14 wherein the power dividers comprise:
a first power divider having a first output that is coupled to an input of the phase shifter and a second output that is coupled to the second column of radiating elements; and
a second power divider whose input is coupled to an output of the phase shifter and a first output that is coupled to the first column of radiating elements and a second output that is coupled to the third column of radiating elements.

16. The switchable antenna of claim 15, wherein the phase shifter comprises a selectively switched phase shifter that switches between providing a phase shift or not providing a phase shift to RF signals received from the output of the first power divider.

17. The switchable antenna of claim 14, wherein the phase shifter comprises an inductive element that is configured to determine an amount of the phase shift when the phase shifter is selectively switched to provide the phase shift.

18. The switchable antenna of claim 15, wherein the phase shifter comprises a diode that is in parallel with an inductance.

19. The switchable antenna of claim 15,
wherein the antenna array includes a total of three columns of radiating elements, and
wherein the first power divider comprises a 1×2 power divider that provides half of an RF energy input thereto to the phase shifter and half of the RF energy to the second column of radiating elements.

20. The switchable antenna of claim 19, wherein the second power divider comprises a 1×2 power divider that provides half of an RF energy input thereto to the first column of radiating elements and half of the RF energy to the third column of radiating elements.

21. A switchable antenna, comprising:
a radio frequency (“RF”) port;
an antenna array that includes at least a first column of radiating elements, a second column of radiating elements and a third column of radiating elements; and
a feed network coupled between the RF port and the antenna array,
wherein the feed network comprises:
a first power divider that has an input that is coupled to the RF port, a first output that is coupled to a phase shifter and a second output that is coupled to the second column of radiating elements; and
a second power divider that has an input that is coupled to the phase shifter, a first output that is coupled to the first column of radiating elements and a second output that is coupled to the third column of radiating elements.

22. The switchable antenna of claim 21, wherein the phase shifter comprises a selectively switched phase shifter that switches between providing a phase shift or not providing a phase shift to RF signals received from the output of the first power divider.

23. The switchable antenna of claim 21, wherein the phase shifter comprises an inductive element that is configured to determine the phase shift when the phase shifter is selectively switched to provide the phase shift.

24. The switchable antenna of claim 21, wherein the phase shifter comprises a diode that is selectively switched to provide a phase shift or not provide the phase shift to the output of the first power divider.

25. The switchable antenna of claim 24, further comprising:
an inductive element that is in parallel with the diode and is configured determine an amount of the phase shift when the phase shifter is selectively switched to provide the phase shift.

29. The switchable antenna of claim 21,
wherein the antenna array includes a total of three columns of radiating elements,
wherein the first power divider comprises a 1×2 power divider that provides half of an RF energy input thereto to the phase shifter and half of the RF energy to the second column of radiating elements, and
wherein the second power divider comprises a 1×2 power divider that provides half of an RF energy input thereto to the first column of radiating elements and half of the RF energy to the third column of radiating elements.
